(19) United States
(12) Patent Application Publication
(10) Pub. No.: US 2013/0120816 A1
(43) Pub. Date: May 16, 2013

(54) THIN FLAT TYPE CONVERGENCE LENS

(71) Applicant: LG DISPLAY CO., LTD., Seoul (KR)

(72) Inventors: Minsung YOON, Paju-si (KR); Sunwoo KIM, Anyang-si (KR); Minyoung SHIN, Paju-si (KR)

(73) Assignee: LG DISPLAY CO., LTD., Seoul (KR)

(21) Appl. No.: 13/678,232

(22) Filed: Nov. 15, 2012

(30) Foreign Application Priority Data
Nov. 15, 2011 (KR) 10-2011-0119190

(51) Int. Cl. G03H 1/04

(52) U.S. Cl. CPC G03H 1/04
USPC 359/19

(57) ABSTRACT

The present disclosure relates to a thin flat type convergence lens. The present disclosure suggests a thin flat type convergence lens including: a transparent substrate; and a film lens including a transparent film attached on one side of the transparent substrate and an interference fringe pattern written on the transparent film. The convergence lens according to the present disclosure has a merit of thin thickness and light weight even if it has large diagonal area, so it is easy to develop thin flat type large area holography 3D display system.

This application claims the benefit of Korean Patent Application No. 10-2011-0119190 filed on Nov. 15, 2011, which is incorporated herein by reference for all purposes as if fully set forth herein.

### BACKGROUND OF THE INVENTION

1. Field of the Invention

The present disclosure relates to a thin flat type convergence lens. Especially, the present disclosure relates to a thin flat type convergence lens for focusing the 3D images in the holography 3D display device.

2. Discussion of the Related Art

Recently, many technologies and researches for making and reproducing the 3D (Three Dimensional) image/video are actively developed. As the media relating to the 3D image/video is a new concept media for virtual reality, it can improve the visual information better, and it will lead the next generation display devices. The conventional 2D image system merely suggests the image and video data projected to plan view, but the 3D image system can provide the full real image data to the viewer. So, the 3D image/video technologies are the True North image/video technologies.

Typically there are three methods for reproducing 3D image/video; the stereoscopy method, the auto-stereoscopy method, the volumetric method, the holography method and the integral imaging method. Among them, the holography method uses laser beam so that it is possible to observe the 3D image/video with naked eyes. The holography method is the most ideal method because it has an excellent visual stereoscopic property without any fatigue of observer.

To produce a recording of the phase of the light wave at each point in an image, holography uses a reference beam which is combined with the light from the scene or object (the object beam). If these two beams are coherent, optical interference between the reference beam and the object beam, due to the superposition of the light waves, produces a series of intensity fringes that can be recorded on standard photographic film. These fringes form a type of diffraction grating on the film, which is called the hologram. The central goal of holography is that when the recorded grating is later illuminated by a substitute reference beam, the original object beam is reconstructed (or reproduced), producing a 3D image/video.

There was a new development of the computer generated holography (or CGH) that is the method of digitally generating holographic interference patterns. A holographic image can be generated e.g. by digitally computing a holographic interference pattern and printing it onto a mask or film for subsequent illumination by suitable coherent light source. the holographic image can be brought to life by a holographic 3D display, bypassing the need of having to fabricate a “hardcopy” of the holographic interference pattern each time.

Computer generated holograms have the advantage that the objects which one wants to show do not have to possess any physical reality at all. If holographic data of existing objects is generated optically, but digitally recorded and processed, and brought to display subsequently, this is termed CGH as well. For example, a holographic interference pattern is generated by a computer system and it is sent to a spatial light modulator such as LCSML (Liquid Crystal Spatial Light Modulator), then the 3D image/video corresponding to the holographic interference pattern is reconstructed/reproduced by radiating a reference beam to the spatial light modulator. FIG. 1 is the structural drawing illustrating the digital holography image/video display device using the computer generated holography according to the related art.

Referring to FIG. 1, the computer 10 generates a holographic interference pattern of an image/video data to be displayed. The generated holographic interference pattern is sent to a SLM 20. The SLM 20, as a transmittive liquid crystal display device, can represent the holographic interference pattern. At one side of the SLM 20, a laser source 30 for generating a reference beam is located. In order to radiate the reference beam 90 from the laser source 30 onto the whole surface of the SLM 20, an expander 40 and a lens system 50 can be disposed, sequentially. The reference beam 90 out from the laser source 30 is radiated to one side of the SLM 20 passing through the expander 40 and the lens system 50. As the SLM 20 is a transmittive liquid crystal display device, a 3D image/video corresponding to the holography interference pattern will be reconstructed/reproduced at the other side of the SLM 20.

The holography type 3D display system according to the FIG. 1 comprises a light source 30 for generating the reference light 90, an expander 40 and a lens system 50 which have relatively large volume. In case that this kind 3D display system is configured, it may have large volume and huge weight. That is, the conventional arts for the holography type 3D display system are not adequate to apply to the thin, light and portable display systems which are recently required. Therefore, it is required to develop a thin flat type holography 3D display system which can represent the real 3D images with the naked eyes.

Even though the SLM, one of main elements for the holography 3D display device, is configured in a thin flat type, if the conventional convergence optical lens (or convex lens) is applied, the total 3D display system cannot be the thin flat type. Furthermore, as the display area of the holography system is getting larger and larger, the lens also should have larger and larger size corresponding to the large display area. For the convex lens, the thickness of the lens is getting thicker and the weight is also getting heavier as the area is larger, so that it is harder to apply for the thin flat type 3D display device.

### SUMMARY OF THE INVENTION

In order to overcome the above mentioned drawbacks, the purpose of the present disclosure is to suggest a thin flat type convergence lens converging the plane wave light having an incidence angle parallel to the propagation direction of the light to certain point on the light (propagation) axis. Another purpose of the present disclosure is to suggest a thin flat type convergence lens which can be applied to the thin flat panel type holography 3D display device (or system).

In order to accomplish the above purpose, the present disclosure suggests thin flat type convergence lens comprises: a transparent substrate; and a film lens including a transparent film attached on one side of the transparent substrate and an interference fringe pattern written on the transparent film.

The interference fringe pattern is made by an interference between a converging light and a parallel straight light perpendicularly incident into the transparent film.

The parallel straight light is made by an interference fringe pattern written on a master film and configured to change an inclined parallel light incident to the master film with an incidence angle into the parallel straight light.

The incident angle of the inclined parallel light is one value among range of 45°±30° to a normal line of the master film.

The converging light is made by an optical convex lens and is focused on an incident surface of the master film and then is diverged to the transparent film.

The film lens includes a photo sensitive film having a thickness of 500 micrometer at most.

The film lens includes one of a transparent photopolymer and a transparent gelatin.

The transparent substrate and the film lens have the same refraction index.

The convergence lens according to the present disclosure comprises one film type convergence lens having the interference fringe pattern therein. Therefore, for configuring the 3D display device, it is possible to set a focus of the 3D images on a point within the space between the display and the observer, or on the observer's eye (pupil or retina) using the thin film type lens. That is, it is possible to make the holography 3D display system in a thin flat type display. Furthermore, the convergence lens according to the present disclosure has a merit of thin thickness and light weight even if it has large diagonal area, so it is easy to develop thin flat type large area holography 3D display system.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is the structural view illustrating the digital holography image/video display device using the computer generated holography according to the related art.

FIG. 2 is a structural view illustrating the digital holography image/video display device using a transmittive liquid crystal display device according to the first embodiment of the present disclosure.

FIG. 3 a schematic view illustrating a method for writing an interference fringe pattern on a transparent writing medium by radiating a parallel straight light and a converging light thereto at the same time.

FIG. 4 is a schematic view illustrating that the parallel straight light is converged by the thin flat type convergence lens according FIG. 3.

FIG. 5 is a cross sectional view illustrating the structure of the thin flat type convergence lens according to the second embodiment of the present disclosure.

FIG. 6A is a schematic view illustrating the method for manufacturing a master film for making the film lens in a mass production system.

FIG. 6B is a schematic view illustrating the method for manufacturing the film lens using the master film.

FIG. 7A is a cross sectional view illustrating the light path representing that the parallel straight light is changed to a conversing light by the film lens.

FIG. 7B is a cross sectional view illustrating the light path representing that the diverging light is changed to a parallel straight light by the film lens.

FIG. 8 is a schematic view illustrating that the 3D images are focused on the observer's eye in the holography 3D display system having the thin flat type convergence lens according to the second embodiment of the present disclosure.

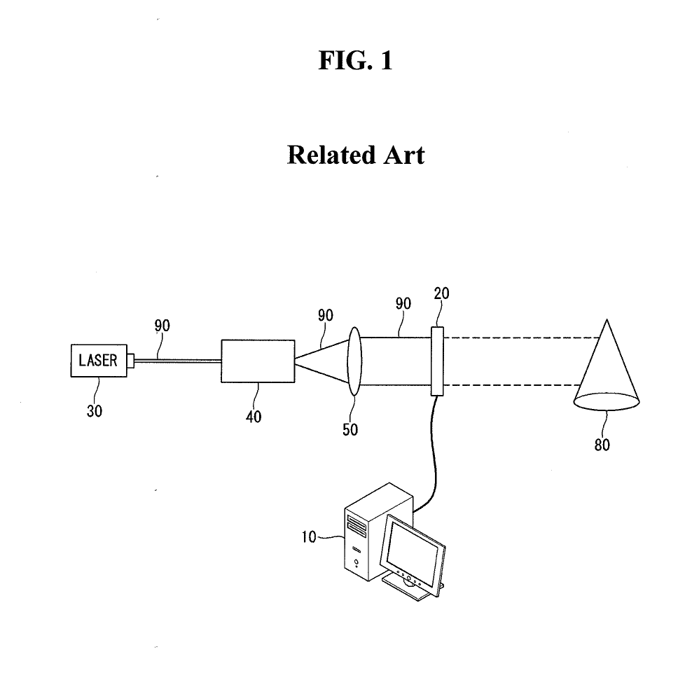

### DETAILED DESCRIPTION OF THE ILLUSTRATED EMBODIMENTS

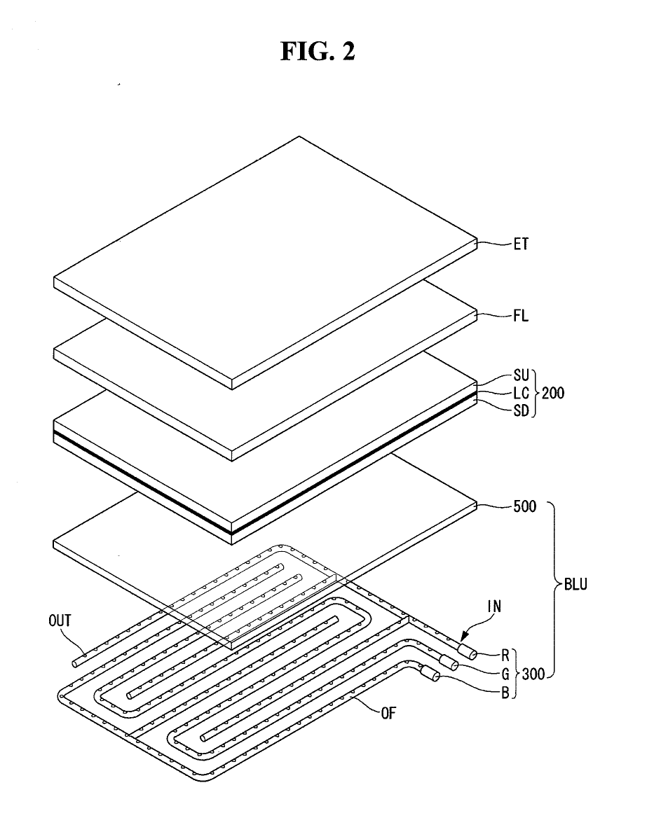

Referring to attached figures, FIGS. 2 to 8, we will explain preferred embodiments of the present disclosure. Like reference numerals designate like elements throughout the detailed description. However, the present disclosure is not restricted by these embodiments but can be applied to various changes or modifications without changing the technical spirit. In the following embodiments, the names of the elements are selected by considering the easiness for explanation so that they may be different from actual names.

Referring to FIG. 2, we will explain a thin flat type holography 3D display device using a transmittive liquid crystal display is used as the space light modulator according to the first embodiment of the present disclosure. FIG. 2 is a structural drawing illustrating the digital holography image/video display device using a transmittive liquid crystal display device according to the first embodiment of the present disclosure.

The holography 3D display device according to the first embodiment of the present disclosure comprises a SLM 200 made of the transmittive liquid crystal display panel. The SLM 200 comprises a upper substrate SU and a lower substrate SD which are made of transparent glass substrate and faced each other, and a liquid crystal layer LC sandwiched between the upper substrate SU and the lower substrate SD. The SLM 200 may represent the interference fringe patterns by receiving the data relating to the interference fringe patterns from a computer or video processor (not shown in figures). The upper substrate SU and the lower substrate SD may have the thin film transistors and the color filters for comprising the liquid crystal display panel, respectively.

At the rear side of the SLM 200, a back light unit BLU comprising a light source 300 and a optical fiber OF may be disposed. The light source 300 may be a set of laser diodes including a red laser diode R, a green laser diode G and a blue laser diode B, or a set of collimated LED including a red LED, a green LED and a blue LED. In addition, the light source 300 may include other color light source than red, green and blue color light sources. Otherwise, the light source 300 may have one source like a white laser diode or a white collimated LED. There may be many kinds of the light source 300. In these embodiments, the light source 300 is explained as comprising the red, green and blue laser diodes, in convenient.

In order to guide a reference light from the light source 300 to the SLM 200 and in order to distribute the reference light over the whole area of the rear surface of the SLM 200, it is preferable to use optical fibers OF. For example, red, green and blue laser diodes R, G and B are disposed at one side of the back light unit BLU. Using the optical fibers OF, the laser beam irradiated from the laser diodes R, G and B can be guided as it reaches to the rear surface of the SLM 200. The optical fiber OF may be disposed as covering the whole surface of the SLM 200, the liquid crystal display. Especially, by removing some portions of the clad wrapping the core of the optical fiber OF in order to form a plurality of light points OUT, the laser beam may be irradiated over the whole surface of the liquid crystal display panel, SLM 200. Furthermore, in order to radiate the reference light expanded and irradiated by the optical fiber OF over whole surface of the SLM 200 evenly and to be a collimated light, a plurality of optical sheets 500 may be disposed between the SLM 200 and the optical fiber OF.

In the present disclosure, the back light unit BLU is one exemplary schematic structure using the optical fiber OF. In the case that the color pixels comprising the SLM 200 are disposed as one kind color is arrayed along the column, one optical fiber OF corresponding to one kind of color may be disposed as matching to the same color column. For another example, the back light unit BLU may comprise a surface emitting LED disposed at each color pixel. As the main concept of the present disclosure is not on the back light unit BLU, the detailed explanations for the back light unit BLU will not be mentioned.

In front of the SLM 200, at a proper position in the space between the observer and the SLM 200, a thin flat converge lens FL may be further included for focusing the 3D images. The focal point of the flat lens FL may be set in various. For example, the focal point may be set on an optimized position between the SLM 100 and the observer. For another example, the focal point may be set on the eye of the observer directly. In this case, the left-eye image and the right-eye image are sent to the left eye and the right eye, respectively. The thin flat converge lens F, one of the main feature of the present disclosure, will be mentioned in detail.

Furthermore, an eye-tracker ET may be included in front of the flat lens FL. When the observer's position is changed, the eye-tracker ET may detect the changed observer's position, calculates the optimized viewing angle for the moved observer, and then deflects the focal point of the 3D images according to the new optimized viewing angle of the observer. For example, the eye-tracker ET may be a deflector for moving the focal point of the 3D images in horizontal direction according to the observer's position. Even though not showing in figures, the eye-tracker ET may further comprise a position detector for detecting the observer's position. As the main feature of the present disclosure is not on the eye-tracker ET, the detailed explanation for the flat lens will not be mentioned.

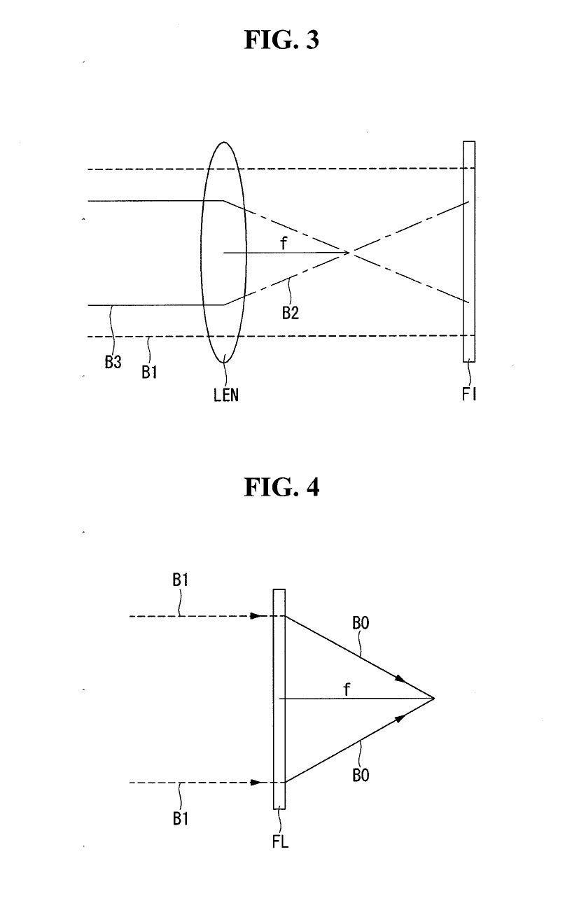

Hereinafter, we will explain about the thin flat type convergence lens according to the present disclosure in detail. FIG. 3 a schematic view illustrating a method for writing an interference fringe pattern on a transparent writing medium by radiating a parallel straight light and a converging light thereto at the same time. FIG. 4 is a schematic view illustrating that the parallel straight light is converged by the thin flat type convergence lens according FIG. 3. Referring to FIG. 3, the basic concept of the thin flat type convergence lens according to the present disclosure will be explained at first.

A flat film FI, a transparent writing medium, is prepared for making the thin flat type lens. From the left side of the flat film FI, a first parallel straight light B1 and a converging light B2 are radiated at the same time to the flat film FI. The converging light B2 can be made by radiating a second parallel straight light B3 to a convex lens LEN. Then, on the flat film FL, an interference fringe pattern between the first parallel straight light B1 and the converging light B2 is written. This flat film FL having the interference fringe pattern would be the thin flat type convergence lens FL.

Referring to FIG. 4, we will explain about the path of the light passing through the thin flat type convergence lens according to the first embodiment of the present disclosure. From the left side of the thin flat type convergence lens FL, when a parallel straight light B1 is radiated to the thin flat type convergence lens FL, after passing through the thin flat type convergence lens FL, the parallel straight light B1 will be changed to and emitted as a converging light BO having the same focus (or focal point) f with the converging light B2, by the interference fringe pattern.

In actual, it is hard to make the thin flat type convergence lens FL according to the method by the first embodiment of the present application. The reason is that as shown in FIG. 3, the convex lens LEN is placed within the path of the first parallel straight light B1 so that the first parallel straight light B1 and the converging light B2 cannot be radiated onto the flat film FI, the writing medium, at the same time.

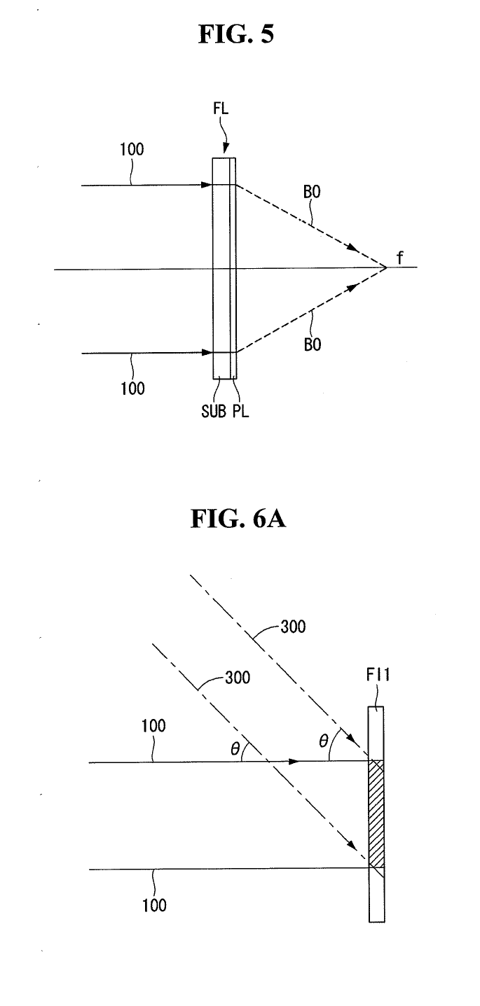

In order to solve the problem of the first embodiment, the second embodiment suggests one of actually possible methods for manufacturing the thin flat type convergence lens. FIG. 5 is a cross sectional view illustrating the structure of the thin flat type convergence lens according to the second embodiment of the present disclosure.

Referring to FIG. 5, the thin flat type convergence lens FL according to the second embodiment of the present disclosure comprises a transparent substrate SUB and a film lens PL attached at one side of the transparent substrate SUB. The transparent substrate SUB may be one of the optically transparent glass substrate and the transparent film. Furthermore, the transparent substrate SUB may be preferably made of a transparent material having the same refractive index with that of the film lens PL.

The film lens PL is a grating film configured to convert a parallel straight light 100, having the incidence angle of 0° about the light propagation axis, to a converging light B0 to the focus f. The film lens PL may be a photo sensitive film having the thickness of 500 um (micrometer). In detail, the film lens PL may comprise a photo sensitive high molecular material such as photopolymer or gelatin. Especially, the film lens PL preferably comprises the material having the same refraction index with that of the transparent substrate SUB.

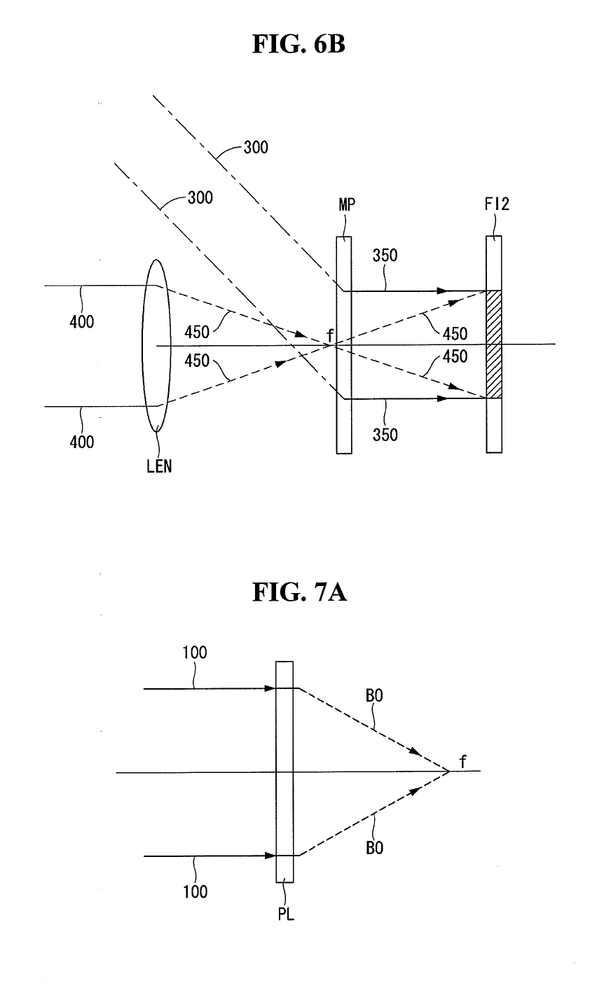

Hereinafter, referring to FIGS. 6A and 6B, we will explain about the film lens PL according to the second embodiment of the present disclosure. FIG. 6A is a schematic view illustrating the method for manufacturing a master film for making the film lens in a mass production system. FIG. 6B is a schematic view illustrating the method for manufacturing the film lens using the master film.

For making a thin flat type master film MP, a first flat film FI1, a transparent optical writing medium, is prepared. From the left side of the first flat film FI1, a parallel straight light 100 and an inclined parallel light 300 are radiated to the first flat film FI1, as the same time. The parallel straight light 100 is incident into the surface of the first flat film FI1 with the incidence angle range of 0°±5° to the normal line of the first flat film FI1. The inclined parallel light 300 is incident into the surface of the first flat film FI1 with the incidence angle range of 0°±5° to the normal line of the first flat film FI1. Then, on the first flat film FI1, an interference fringe pattern by the parallel straight light 100 and the inclined parallel light 300 is written. That is, the first flat film FI1 having this interference fringe pattern would be the master film MP.

Here, the incidence angle θ of the inclined parallel light 300 is selected as the inclined parallel light 300 can be fully radiated into the first flat film FI1 without any interferences with the optical devices used for making the converging light B2 shown in FIG. 3. Furthermore, the incidence angle should not effect on the diffraction effect of the interference fringe pattern. In various experiences, the incidence angle θ of the inclined parallel light 300 would preferably be 45°±30° to the normal line of the first flat film FI1. More preferably, the incidence angle θ of the inclined parallel light 300 can be selected any one value among range of 39° to 41°. According to the experiments and simulations, the incidence angle θ of the inclined parallel light 300 can be selected any one angle range of 39.2° to 40.2°. For the most optimized case, the incidence angle θ of the inclined parallel light 300 is 39.8°.

After that, using the master film MP, the film lens PL can be manufactured. Referring to FIG. 6B, we will explain the method for manufacturing the film lens PL by radiating the inclined parallel light 300 and the converging light 450 to the master film MP at the same time.

For making a film lens PL, a second flat film FI2, a transparent optical writing medium, is prepared. The master film MP is disposed at the left side of the second flat film FI2. From the left side of the master film MP opposition to the second flat film FI2, the converging light 450 and the inclined parallel light 300 are radiated to the master film MP, at the same time.

The inclined parallel light 300 is radiated to the master film MP from the left side of the master film MP with the incidence angle θ range of 45°±30° to the normal line of the master film MP. Then, passing through the master film MP, the inclined parallel light 300 is diffracted by the interference fringe pattern written on the master film MP, it is changed to the parallel straight light 350, and then it is emitted to the second flat film FI2.

On the other hands, the converging light 450 can be made by radiating a second parallel straight light 400 to a convex lens LEN. Here, the focus f of the converging light 450 would be set, on any point located in the space between the convex lens LEN and the second flat film FI2. More preferably, the focus f of the converging light 450 should be set on the point where the converging light 450 is focused on incidence surface of the master film MP. As the interference fringe pattern of the master film MP does not have any component from the converging light 450, the converging light 450 is passing through the master film MP without any diffraction by the interference fringe pattern of the master film MP. That is, the converging light 450 is diverged from the focus f and is radiated into the second flat film FI2.

As a result, an interference fringe pattern generated by the converging light 450 and the parallel straight light 350 is written on the second flat film FI2. The second flat film FI2 having the interference fringe pattern would be the film lens PL. The focal point f of the convex lens LEN is located at −f point, in the aspect of the second flat film FI2, the film lens PL. When a parallel straight light is radiated into the second flat film FI2 from the left side of the second flat film FI2, a converging light is emitted from the second flat film FI2 to the focal point f (f position to the right side of the second flat film FI2). On the contrary, when a parallel straight light is radiated into the second flat film FI2 from the right side of the second flat film FI2, a converging light is emitted from the second flat film FI2 to the focal point −f (f position to the left side of the second flat film FI2).

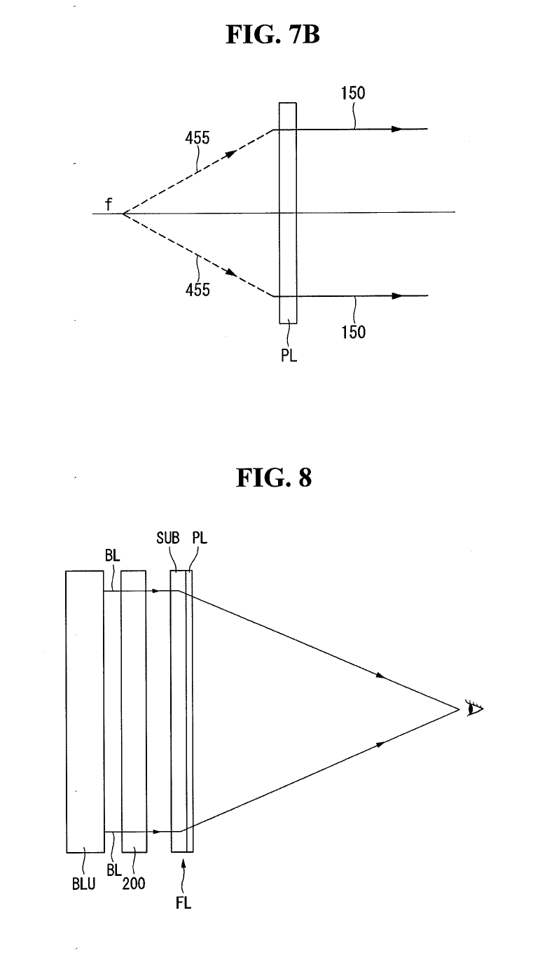

Referring to FIGS. 7A and 7B, we will explain about the operation of the film lens using the path of the light passing the film lens PL manufactured according to the second embodiment of the present disclosure. FIG. 7A is a cross sectional view illustrating the light path representing that the parallel straight light is changed to a conversing light by the film lens. FIG. 7B is a cross sectional view illustrating the light path representing that the diverging light is changed to a parallel straight light by the film lens.

As the parallel straight light 100 is radiated to the film lens PL from the left side of the film lens PL according to the second embodiment of the present disclosure, as shown in the FIG. 7A, after passing the interference fringe pattern written on the film lens PL, it is changed into the converging light BO focused to the focal point f. On the other hand, when a converging light 455 having focus f is radiated into the film lens PL from the left side of the film lens PL, as shown in FIG. 7B, after passing the interference fringe pattern written on the film lens PL, it is changed into the parallel straight light 150 parallel to the normal line to the surface of the film lens PL.

The thin flat type convergence lens FL according to the second embodiment of the present disclosure can be applied to the holography 3D display system. FIG. 8 is a schematic view illustrating that the 3D images are focused on the observer's eye in the holography 3D display system having the thin flat type convergence lens according to the second embodiment of the present disclosure. Referring to FIG. 8, the back light BL radiated from the back light unit BLU can represent the holography 3D images by the spatial light modulator (SLM) 200. The holography 3D images can be focused on the focal point of the thin flat type convergence lens. For one example, the light for representing the holography 3D images can be converged on the observer's eye so that it is possible to provide the high quality holography 3D images.

While the embodiment of the present invention has been described in detail with reference to the drawings, it will be understood by those skilled in the art that the invention can be implemented in other specific forms without changing the technical spirit or essential features of the invention. Therefore, it should be noted that the forgoing embodiments are merely illustrative in all aspects and are not to be construed as limiting the invention. The scope of the invention is defined by the appended claims rather than the detailed description of the invention. All changes or modifications or their equivalents made within the meanings and scope of the claims should be construed as falling within the scope of the invention.

What is claimed is:

1. A thin flat type convergence lens comprising:
a transparent substrate; and
a film lens including a transparent film attached on one side of the transparent substrate and an interference fringe pattern written on the transparent film.

2. The thin flat type convergence lens according to the claim 1, wherein the interference fringe pattern is made by an interference between a converging light and a parallel straight light perpendicularly incident into the transparent film.

3. The thin flat type convergence lens according to the claim 2, wherein the parallel straight light is made by an interference fringe pattern written on a master film and configured to change an inclined parallel light incident to the master film with an incidence angle into the parallel straight light.

4. The thin flat type convergence lens according to the claim 3, wherein the incident angle of the inclined parallel light is one value among range of 45°±30° to a normal line of the master film.

5. The thin flat type convergence lens according to the claim 3, wherein the converging light is made by an optical convex lens and is focused on an incident surface of the master film and then is diverged to the transparent film.

6. The thin flat type convergence lens according to the claim 1, wherein the film lens includes a photo sensitive film having a thickness of 500 micrometer at most.

7. The thin flat type convergence lens according to the claim 1, wherein the film lens includes one of a transparent photopolymer and a transparent gelatin.

8. The thin flat type convergence lens according to the claim 1, wherein the transparent substrate and the film lens have the same refraction index.
